(19) United States
(12) Patent Application Publication
(10) Pub. No.: US 2017/0255471 A1
(43) Pub. Date: Sep. 7, 2017

(54) PROCESSOR WITH CONTENT ADDRESSABLE MEMORY (CAM) AND MONITOR COMPONENT

(71) Applicant: GLOBALFOUNDRIES INC., Grand Cayman (KY)

(72) Inventors: Jack R. Smith, South Burlington, VT (US); Sebastian T. Ventrone, South Burlington, VT (US); Ezra D. B. Hall, Richmond, VT (US)

(21) Appl. No.: 15/062,302

(22) Filed: Mar. 7, 2016

(51) Int. Cl. G06F 9/38; G06F 9/30; G06F 12/08; G06F 3/06

(52) U.S. Cl. CPC G06F 9/3867; G06F 3/0611; G06F 3/0653; G06F 3/0673; G06F 9/3005; G06F 9/3016; G06F 9/3802; G06F 12/0875; G06F 2212/452

(57) ABSTRACT

Various embodiments include processors for processing operations. In some cases, a processor includes: an instruction fetch component configured to fetch processing instructions; an instruction cache component connected with the instruction fetch component, configured to store the processing instructions; an execution component connected with the instruction cache component, configured to execute the processing instructions; a monitor component connected with the execution component, configured to receive execution results from the processing instructions; and a content addressable memory (CAM) component connected with the instruction fetch component and the monitor component, wherein the monitor component stores a portion of the execution results in the CAM for subsequent use in bypassing the execution component.

### FIELD

The subject matter disclosed herein relates to processors. More particularly, the subject matter disclosed herein relates to pipeline processing and ordering of operations in processing.

### BACKGROUND

Conventional pipeline processing follows prescribed steps including: 1) accessing an instructions cache; 2) decoding the instructions from the cache; 3) fetching source operands based upon the decoded instructions; and 4) executing the instructions using the source operands. However, latency (delay) can last several cycles, which can impact processing performance and stall this process. This can be especially true where fetching source operands requires more time than expected. Further, where an operation is repeated several times (e.g., code is running in a loop), each time instructions are executed a specific amount of power is dissipated, increasing power requirements of the processor.

### BRIEF DESCRIPTION

Various embodiments of the disclosure include processors for processing operations. In some cases, a processor includes: an instruction fetch component configured to fetch processing instructions; an instruction cache component connected with the instruction fetch component, configured to store the processing instructions; an execution component connected with the instruction cache component, configured to execute the processing instructions; a monitor component connected with the execution component, configured to receive execution results from the processing instructions; and a content addressable memory (CAM) component connected with the instruction fetch component and the monitor component, wherein the monitor component stores a portion of the execution results in the CAM for subsequent use in bypassing the execution component.

A first aspect of the disclosure includes a processor having: an instruction fetch component configured to fetch processing instructions; an instruction cache component connected with the instruction fetch component, configured to store the processing instructions; an execution component connected with the instruction cache component, configured to execute the processing instructions; a monitor component connected with the execution component, configured to receive execution results from the processing instructions; and a content addressable memory (CAM) component connected with the instruction fetch component and the monitor component, wherein the monitor component stores a portion of the execution results in the CAM for subsequent use in bypassing the execution component.

A second aspect of the disclosure includes a processor having: an instruction fetch component configured to fetch processing instructions; an instruction cache component connected with the instruction fetch component, configured to store the processing instructions; an execution component connected with the instruction cache component, configured to execute the processing instructions; a data cache component connected with the execution component, configured to store at least one operand associated with the processing instructions; a monitor component connected with the execution component, configured to receive execution results from the processing instructions; and a content addressable memory (CAM) component connected with the instruction fetch component and the monitor component, wherein the monitor component stores a portion of the execution results in the CAM for subsequent use in bypassing the execution component, wherein the CAM component is arranged in parallel with the instruction cache and the execution component.

A third aspect of the disclosure includes a processor having: an instruction fetch component configured to fetch processing instructions; an execution component connected with the instruction fetch component, configured to execute the processing instructions; a data cache component connected with the execution component, the data cache component storing at least one operand associated with the processing instructions; a monitor component connected with the execution component, configured to receive execution results of the processing instructions from the execution component; and a content addressable memory (CAM) component connected with the instruction fetch component and the monitor component, in parallel with the execution component, wherein the monitor component stores a portion of the execution results in the CAM for subsequent use in bypassing the execution component, based upon at least one of an amount of power dissipated by the execution component during the executing of the processing instructions, or a time required by the execution component to access the at least one operand from the data cache.

### BRIEF DESCRIPTION OF THE FIGURES

These and other features of this invention will be more readily understood from the following detailed description of the various aspects of the invention taken in conjunction with the accompanying drawings that depict various embodiments of the invention, in which:

FIG. 1 shows schematic depiction of a processor according to various embodiments of the disclosure.

FIG. 2 shows a schematic depiction of portions of a content addressable memory according to various embodiments of the disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the subject matter disclosed herein relates to processors. More particularly, the subject matter disclosed herein relates to pipeline processing and ordering of operations in processing

In contrast to conventional approaches, various aspects of the disclosure include a processor system for pipeline processing which utilize one or more content addressable memory (CAM) components to bypass execution of previously run operands to enhance processing speed and reduce power requirements. According to various embodiments, a processor system includes a CAM which bypasses a processor execution unit after detection of a redundant (previously executed) operand. The processor system includes a monitor component (MUX) which monitors operations (and associated instructions) as they pass through the execution unit, and dynamically chooses whether to store the results of those operations (along with instructions) in the CAM for future use. The monitor component can choose which instructions to store based upon one or more factors, such as an amount of power dissipated by the execution unit during execution, and/or a time required to access operands. The monitor component can further analyze whether an operation is likely to happen again (e.g., whether it is a one-time operation), and based upon that likelihood, determine whether the operation is worth storing in the CAM (given the data/storage constraints in the CAM). The monitor component is programmed to determine a likelihood that an operation will be repeated (e.g., does the operation include a loop function, or has a similar function within this operation been previously detected?).

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

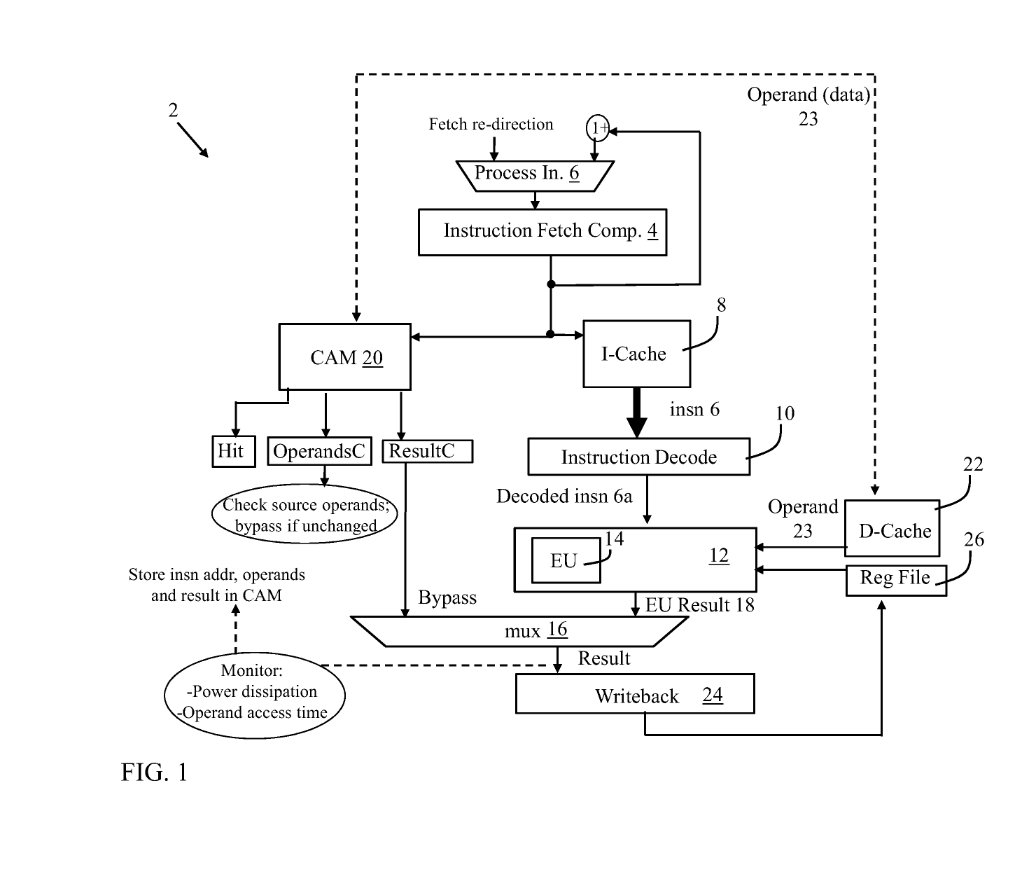

FIG. 1 shows a schematic depiction of a processor 2, including data flows, according to various embodiments of the disclosure. As shown, processor 2 can include an instruction fetch component 4 configured to fetch processing instructions 6. Processing instructions 6 can include instructions for performing particular functions, such as add, subtract, multiply, divide, compare, etc., in a particular order. Processing instructions 6 can be obtained from one or more data packets, programs and/or source code. Processing instructions 6 can take any form capable of decoding and processing known in the art, and may be obtained directly (e.g., from a source of the instructions), or through one or more intermediary sources.

Processor 2 can further include an instruction cache component 8 connected with instruction fetch component 4. Instruction cache component 8 is configured to store processing instructions 6, e.g., for use in execution, further described herein. Processor 2 can additionally include a decoder 10 connected with instruction cache component 8 and an execution component 12 connected with the instruction cache component 8 (via the decoder 10). Decoder 10 is configured to decode processing instructions 6 (resulting in decoded processing instructions 6a) for compatibility with execution component 12. In some cases, execution component 12 includes an execution unit 14, which is configured to execute decoded processing instructions 6a.

According to various embodiments, processor 2 can further include a monitor component (MUX) 16 connected with execution component 12. Monitor component 16 can be configured to receive execution results 18 as a result of processing instructions 6 (decoded processing instructions 6a), from execution component 12. Processor 2 can further include a content addressable memory (CAM) component (or simply, CAM) 20 connected with instruction fetch component 4 and monitor component 16. In these cases, monitor component 16 can store a portion of execution results 18 in CAM 20 for subsequent use in bypassing execution component 12. As shown in FIG. 1, CAM 20 is arranged in parallel with instruction cache 8 and execution component 12, between instruction fetch component 4 and monitor component 16. In various embodiments, CAM 20 is configured to count hits from processing instructions 6 for operations, and store operands from the processing instructions 6.

In various embodiments, processor 2 can further include a data cache component (or simply, data cache) 22 connected with execution component 12. Data cache 22 is configured to store at least one operand 23 associated with processing instructions 6. Processor 2 can also include a writeback component 24 connected with monitor component 16. Writeback component 24 can be configured to write (e.g., store) execution results 18 from monitor component 16. Processor 2 can further include a register 26 connected with writeback component 24, where register 26 is configured to log (store, correlate and/or tabulate) execution results 18 and hit counts for processing instructions 6. In various embodiments, CAM 20 is further connected with data cache 22, and can receive stored operands 23, and send operands (and associated hit data) 23 to data cache 22 for subsequent usage, e.g., at execution unit 14, as described herein. That is, CAM 20 can compare operands 23 with processing instructions 6 to determine whether any hits occur; where a hit indicates an instruction (e.g., a portion of code in processing instructions 6) has been previously executed. According to various embodiments, when a hit occurs, CAM 20 executes an OperandsC function, where it compares source operands (e.g., source code within operand(s) 23) with source code in processing instructions 6 to determine whether the processing instructions 6 include code already executed and stored in CAM 20.

According to various embodiments, monitor component 16 is configured to store a portion of execution results 18 (e.g., less than the entirety of execution results 18) in CAM 20, based upon an amount of power dissipated by execution component 12 during the executing of the processing instructions 6 and/or a time required by execution component 12 to access the at least one operand 23 from data cache 22. In various embodiments, monitor component 16 is configured to store the portion of execution results 18 in CAM 20 in response to identifying a loop function in processing instructions 6 and/or identifying a previously executed function in processing instructions 6. According to various embodiments, the loop function and/or the previously executed function indicate a likelihood of a subsequent repeat function, which may make storing the portion of execution results 18 useful to bypass that subsequent repeat function (and save execution resources and time). The monitor component 16 can initiate a bypass of execution component 12 in response to determining a portion of execution results 18 for one or more processing instructions are present in CAM 20, and in some cases, monitor component 16 can fetch that portion of execution results 18 from CAM 20.

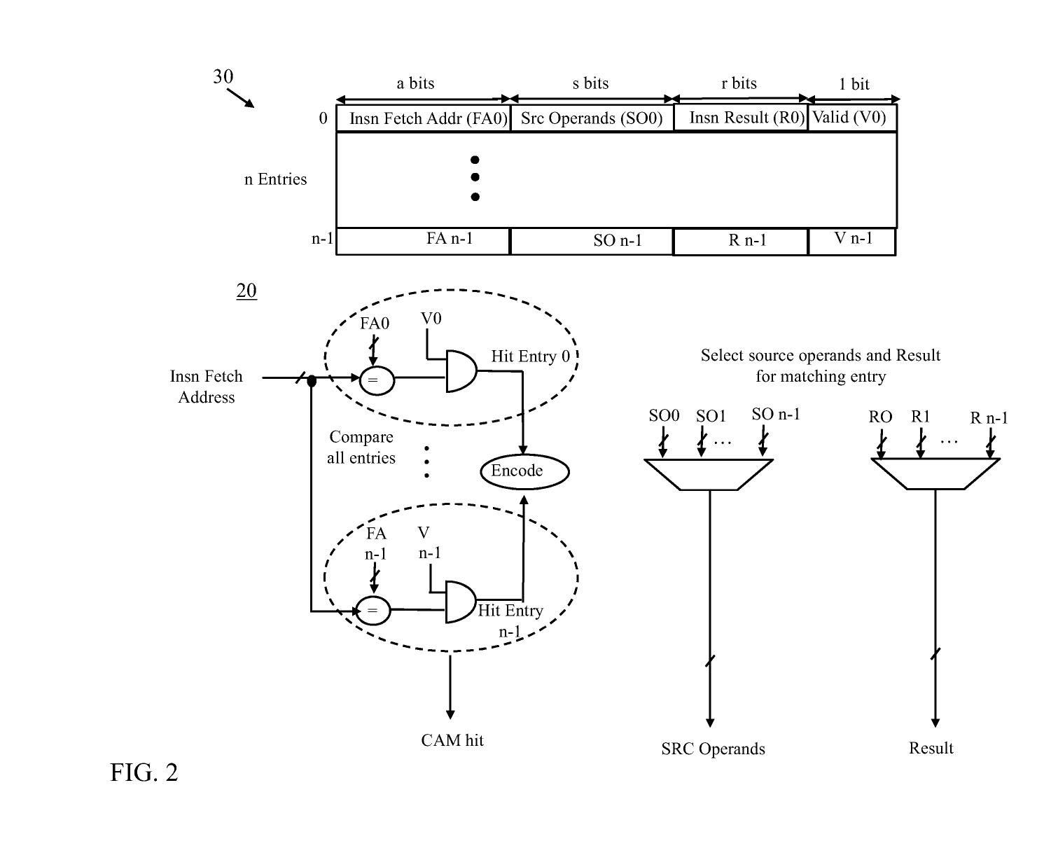

FIG. 2 shows a schematic depiction of internal data flow within CAM 20. As shown, the CAM 20 includes a CAM array 30 having n entries (rows). Each of the n entries contains an instruction fetch address (FA0), source operand (SO0), instruction result (R0) and valid bit (V0). As shown in FIG. 2, the fetch address (FA0) is compared against all entries to select a matching line, and a “hit” indicates the CAM array 30 has a result for a given instruction (R0). That is, as noted herein, a hit indicates an instruction (e.g., a portion of code in processing instructions 6) has been previously executed. According to various embodiments, when a hit occurs, CAM array 30 executes an OperandsC function, where it compares source operands (SO0) with source code (R0) in processing instructions 6 to determine whether the processing instructions 6 include code (R0) already executed and stored in CAM 20.

In any case, the technical effect of the various embodiments of the invention, including, e.g., processor 2, is to process operating instructions. It is understood that according to various embodiments, the processor 2 could be implemented to analyze a plurality of ICs (e.g., ASIC design data 60 for forming one or more ASICs), as described herein.

As used herein, the term “configured,” “configured to” and/or “configured for” can refer to specific-purpose features of the component so described. For example, a system or device configured to perform a function can include a computer system or computing device programmed or otherwise modified to perform that specific function. In other cases, program code stored on a computer-readable medium (e.g., storage medium), can be configured to cause at least one computing device to perform functions when that program code is executed on that computing device. In these cases, the arrangement of the program code triggers specific functions in the computing device upon execution. In other examples, a device configured to interact with and/or act upon other components can be specifically shaped and/or designed to effectively interact with and/or act upon those components. In some such circumstances, the device is configured to interact with another component because at least a portion of its shape complements at least a portion of the shape of that other component. In some circumstances, at least a portion of the device is sized to interact with at least a portion of that other component. The physical relationship (e.g., complementary, size-coincident, etc.) between the device and the other component can aid in performing a function, for example, displacement of one or more of the device or other component, engagement of one or more of the device or other component, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A processor comprising:
an instruction fetch component configured to fetch processing instructions;
an instruction cache component connected with the instruction fetch component, configured to store the processing instructions;
an execution component connected with the instruction cache component, configured to execute the processing instructions;
a monitor component connected with the execution component, configured to receive execution results from the processing instructions; and
a content addressable memory (CAM) component connected with the instruction fetch component and the monitor component, wherein the monitor component stores a portion of the execution results in the CAM for subsequent use in bypassing the execution component.

2. The processor of claim 1, wherein the CAM component is arranged in parallel, between the instruction fetch component and the monitor component, with the instruction cache and the execution component.

3. The processor of claim 1, further comprising a data cache component connected with the execution component, the data cache component storing at least one operand associated with the processing instructions.

4. The processor of claim 3, wherein the monitor component stores the portion of the execution results in the CAM based upon at least one of an amount of power dissipated by the execution component during the executing of the processing instructions, or a time required by the execution component to access the at least one operand from the data cache.

5. The processor of claim 1, wherein the monitor component is configured to store the portion of the execution results in the CAM in response to at least one of identifying a loop function in the processing instructions or identifying a previously executed function in the processing instructions.

6. The processor of claim 5, wherein the at least one of the loop function or the previously executed function indicate a likelihood of a subsequent repeat function.

7. The processor of claim 1, further comprising a decoder between the instruction cache and the execution component for decoding the processing instructions.

8. The processor of claim 7, wherein the execution component executes the decoded processing instructions received form the decoder.

9. The processor of claim 1, wherein the CAM is further configured to count hits from the processing instructions for operations and store operands from the processing instructions.

10. The processor of claim 9, further comprising:
a writeback component connected with the monitor component, the writeback component configured to write the execution results; and
a register connected with the writeback component, the register for logging the execution results and the hit counts for the processing instructions.

11. The processor of claim 10, wherein the monitor component is configured to initiate a bypass of the execution component in response to determining a portion of the execution results for a processing instruction are present in the CAM, wherein the monitor component is further configured to fetch the portion of the execution results from the CAM.

12. The processor of claim 1, wherein the processing instructions include instruction operands, and wherein the CAM is further configured to indicate a hit in response to determining a portion of the execution results match a corresponding portion of the instruction operands.

13. A processor comprising:
an instruction fetch component configured to fetch processing instructions;
an instruction cache component connected with the instruction fetch component, configured to store the processing instructions;
an execution component connected with the instruction cache component, configured to execute the processing instructions;
a data cache component connected with the execution component, configured to store at least one operand associated with the processing instructions;
a monitor component connected with the execution component, configured to receive execution results from the processing instructions; and
a content addressable memory (CAM) component connected with the instruction fetch component and the monitor component, wherein the monitor component stores a portion of the execution results in the CAM for subsequent use in bypassing the execution component, wherein the CAM component is arranged in parallel with the instruction cache and the execution component.

14. The processor of claim 13, wherein the monitor component stores the portion of the execution results in the CAM based upon at least one of an amount of power dissipated by the execution component during the executing of the processing instructions, or a time required by the execution component to access the at least one operand from the data cache.

15. The processor of claim 13, wherein the monitor component is configured to store the portion of the execution results in the CAM in response to at least one of identifying a loop function in the processing instructions or identifying a previously executed function in the processing instructions.

16. The processor of claim 15, wherein the at least one of the loop function or the previously executed function indicate a likelihood of a subsequent repeat function.

17. The processor of claim 13, further comprising a decoder between the instruction cache and the execution component for decoding the processing instructions.

18. The processor of claim 17, wherein the execution component executes the decoded processing instructions received form the decoder.

19. The processor of claim 13, wherein the CAM is further configured to count hits from the processing instructions for operations and store operands from the processing instructions, the processor further comprising:
a writeback component connected with the monitor component, the writeback component configured to write the execution results; and
a register connected with the writeback component, the register for logging the execution results and the hit counts for the processing instructions, wherein the monitor component is configured to initiate a bypass of the execution component in response to determining a portion of the execution results for a processing instruction are present in the CAM, wherein the monitor component is further configured to fetch the portion of the execution results from the CAM.

20. A processor comprising:
an instruction fetch component configured to fetch processing instructions;
an execution component connected with the instruction fetch component, configured to execute the processing instructions;
a data cache component connected with the execution component, the data cache component storing at least one operand associated with the processing instructions;
a monitor component connected with the execution component, configured to receive execution results of the processing instructions from the execution component; and
a content addressable memory (CAM) component connected with the instruction fetch component and the monitor component, in parallel with the execution component, wherein the monitor component stores a portion of the execution results in the CAM for subsequent use in bypassing the execution component, based upon at least one of an amount of power dissipated by the execution component during the executing of the processing instructions, or a time required by the execution component to access the at least one operand from the data cache.
